(19) United States
(12) Patent Application Publication
(10) Pub. No.: US 2004/0138019 A1
(43) Pub. Date: Jul. 15, 2004

(54) Detachable freewheel turner for a bicycle

(76) Inventor: Mao-Shu Liu, Chang Hua (TW)

Correspondence Address: Hart, Baxley Daniels & Holton, Fiffth Floor, 59 John Street, New York, NY, 10038, US

(21) Appl. No.: 10/342,069

(22) Filed: Jan. 13, 2003

(51) Int. Cl. F16H 7/02; F16H 55/12

(52) U.S. Cl. 474/156; 474/153; 474/160

(57) ABSTRACT

A detachable freewheel turner for a bicycle mainly comprises a wrench formed with two through holes and a chain including a plurality of connectors, and at a end of the first connector formed with a hole, a junction plate connected to the two connectors which are adjacent to the hole, a pivot hole formed in the junction plate, the hole and pivot hole in the chain corresponding respectively to the through holes of the wrench. Two pins detachably extend through the through holes in the wrench and the hole and pivot hole in the chain, so as to secure the chain to the wrench.

### FIELD OF THE INVENTION

The present invention relates to a freewheel turner and more particular to a detachable freewheel turner for a bicycle.

### BACKGROUND OF THE INVENTION

Generally, Freewheels used to transmit a driving force to the rear bicycle wheel in one rotation direction only are usually mounted on the rear hub of a bicycle. Freewheels are used so that the bicycle can advance freely without any rotation of the pedals. A freewheel gear cluster of a bicycle comprises a plurality of freewheels with different numbers of teeth, which are rotatably mounted on a rear fork end and rotated by a front chainwheels through a chain to drive the rear wheel of the bicycle. A special tool should be used when the freewheels need to be repaired or refitted so as to prevent the teeth of the freewheel from being distorted.

As shown in FIG. 1, the conventional freewheel turner discloses a tool, which mainly includes a first chain 11 and a second chain 12 both fixed to a wrench 14 by virtue of a pin 13, in such a manner, it can detach a freewheel 151 by cooperating with the first chain 11 and the second chain 12. However, in real operation, there are still some shortcomings need to be improved:

First, in case a connector 111,121 of the first chain 11 and the second chain 12 are broken, it will be a hard work that have to replace the whole broken connector 111,121 by another new one due to the firs chain 11 and the second chain 12 are rigidly fixed to the wrench 14.

Second, after a freewheel 151 of the freewheel gear cluster 15 being disassembled, the wrench 14 will normally be used for loosening or tightening other bolts or nuts of a bicycle, and also due to the firs chain 11 and the second chain 12 are fixed to the wrench 14, it will swing with the movement of the wrench and will be an obstacle during working operation.

### SUMMARY OF THE INVENTION

The prime object of the present invention is to provide a detachable freewheel turner for a bicycle, wherein the chains are attached to a wrench by virtue of two pins and detachable in case of the chain broken.

Another object of the present invention is to provide a detachable freewheel turner for a bicycle, wherein the wrench has two working ends and can be used as a normal wrench after the chains being detached.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an illustrative view of the conventional freewheel turner for a bicycle.

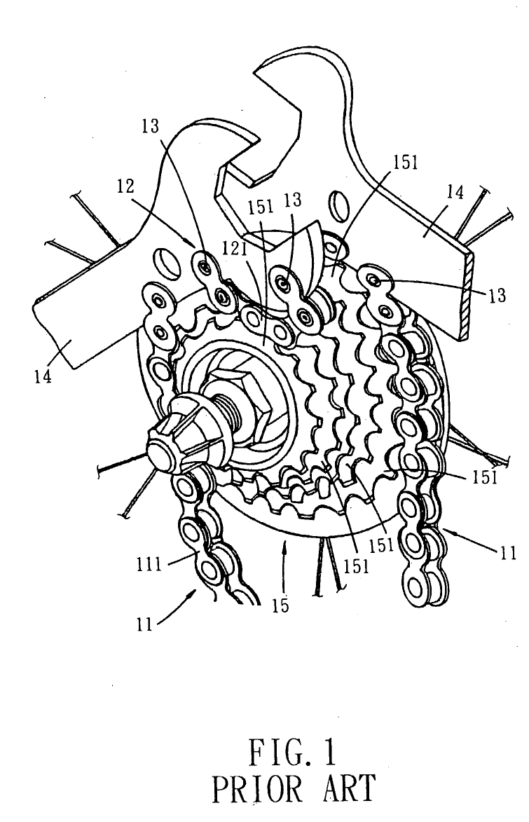

FIG. 2 is an exploded view to show a first embodiment of the present invention.

FIG. 3 is a perspective view to show the first embodiment of the present invention.

FIG. 4 is a cross sectional view, partly in section, to show a pin with steel ball used in a detachable freewheel turner for a bicycle in accordance with the present invention.

FIG. 5 is a cross sectional view, partly in section, to show another embodiment of the pin of the present invention.

FIG. 6 is a cross sectional view, partly in section, to show further embodiment of the pin of the present invention.

FIG. 7 is an elevational view of the detachable freewheel turner for a bicycle to show another position of the chain is fixed.

### DETAILED DESCRIPTION OF THE PREFERRED EMBODIMENTS

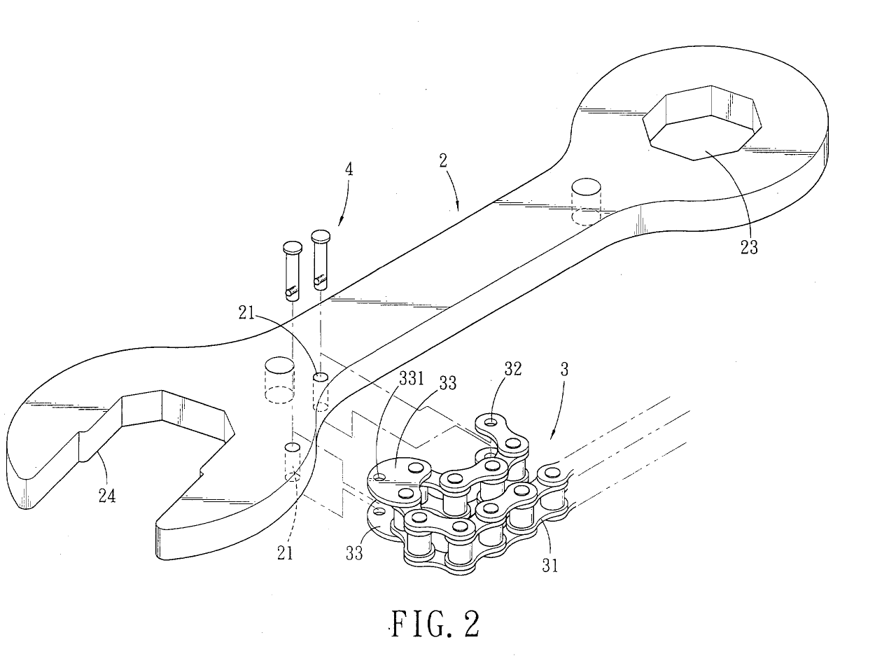

Referring to FIGS. 2 to 4, the detachable freewheel turner for a bicycle of the present invention comprises a wrench 2, a chain 3 and two pins 4. The wrench 2 has a box end 23, an open end 24 and two through holes 21 formed thereon.

The chain 3 includes a plurality of connectors 31, and at an end of the first connector 31 is formed with a hole 32. A junction plate 33 is connected between two connectors 31 which are adjacent to the hole 32. The through holes 21 are respectively in alignment with the hole 32 of the connector 31 and a pivot hole 331 of the junction plate 33 so that two pins 4 may respectively extend through the through holes 21 in the wrench 2 and the hole 32 in the connector 31 and the pivot hole 331 in the junction plate 33 so as to secure the chain 3 to the wrench 2. The pin 4 has a head portion 41 and a body portion 42, and a diameter of the head portion 41 is bigger than that of the body portion 42. A recess 421 is formed at the abutting end of the body portion 42, and a spring 422, a steel ball 423 are put into the recess 421 in turn, the steel ball 423 against the spring 422 may partly protrude out of the recess 421 and can also be compressed back into the recess 421.

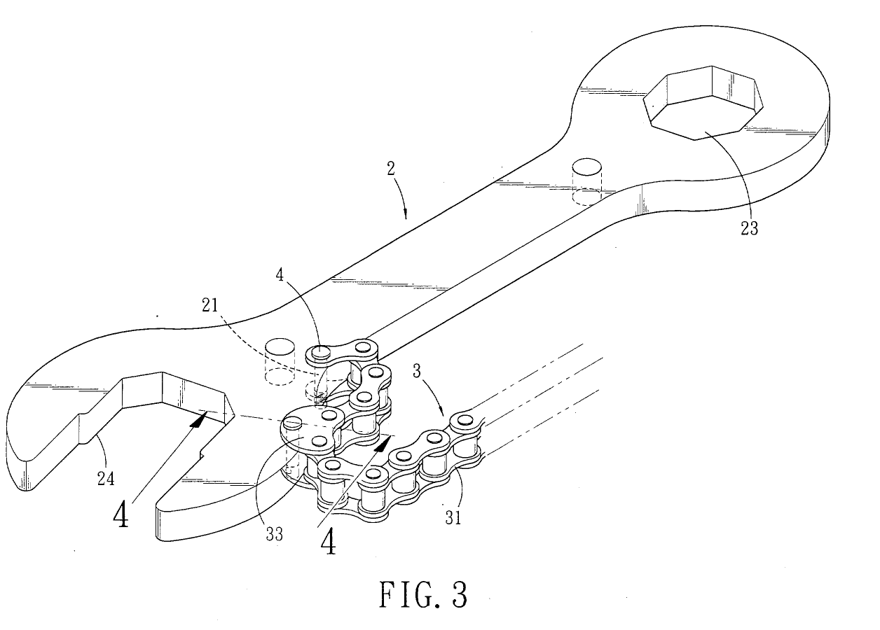

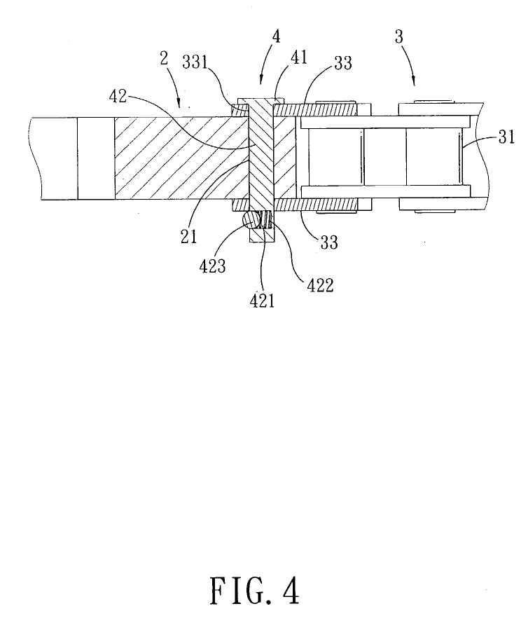

Now referring FIGS. 3-4 again, the wrench 4 can be a tool for disassembling a freewheel when the chain 3 is fixed to the wrench 2 by virtue of the pins 4. While the chain 3 is easily detachable to replace another new one in case of broken, In addition, it will be very convenient for using when it is to be employed only as a wrench after the chain 3 being detached.

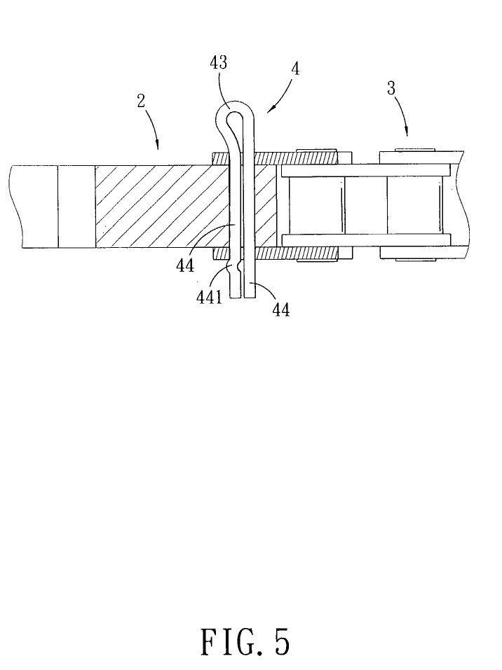

Referring to FIG. 5, it is the second embodiment of the present invention but the main difference is that the pin 4 comprises a head portion 43 and two rod-like portions 44, the size of the head portion 43 is bigger than that of the rod-like portions 44. A protrusion 441 is formed at the abutting end of one of the rod-like portions 44 and may extend through the hole 21, pivot hole 331 and the hole 32 respectively in the wrench 2 and chain 3. In such a manner, the chain 3 can be limited between the head portion 43 and the protrusion 441 and detachably fixed to the wrench 2.

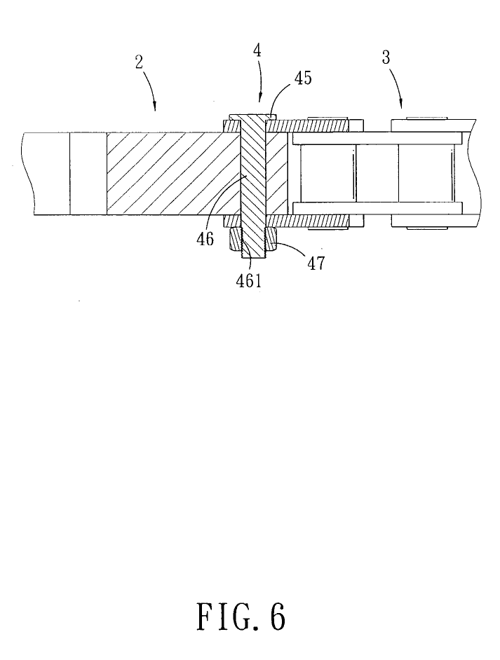

Referring further to FIG. 6, it is the third embodiment of the present invention, in which, the pin 4 has a head portion 45 connected to a body portion 46, the diameter of the head portion 45 is bigger than that of the body portion 46. The body portion 46 has a threaded section 461 which is engaged with a nut 47. In the same way, the chain 3 can be fixed to the wrench 2 by virtue of the pin 4.

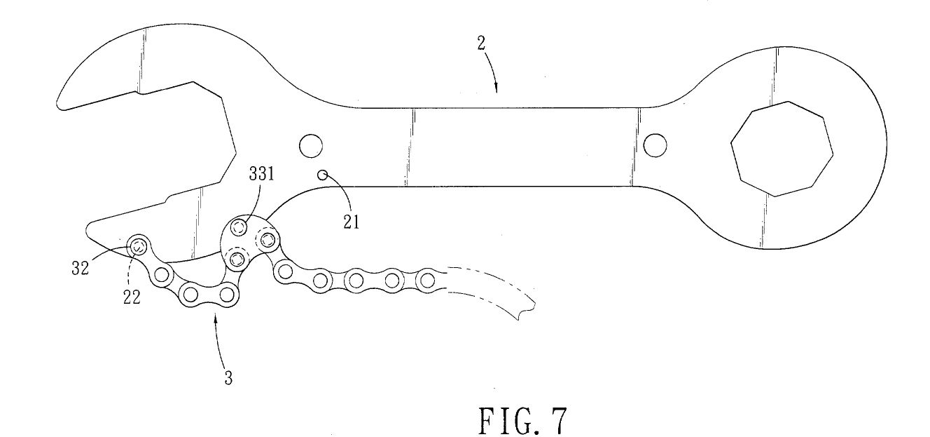

Referring to FIG. 7, in which, a through hole 22 is defined adjacent to the hole 21 in the wrench 2 and located in correspondence with the pivot hole 331 and the hole 32 of the chain 3 so as to adjust the connecting position of the wrench 2 and the chain 3. The chain 3 may be fixed to the wrench 2 according to the user's needs.

While we have shown and described the embodiments in accordance with the present invention, it should be clear to those skilled in the art that further embodiments may be made without departing from the scope of the present invention.

What is claimed is:

1. A detachable freewheel turner for a bicycle comprising:
a wrench formed with two through holes;
a chain including a plurality of connectors, and a end of the first connector formed with a hole, a junction plate being connected to two connectors which are adjacent to the hole, a pivot hole formed in the junction plate, the hole and the pivot hole in the chain corresponding respectively to the through holes of the wrench;
two pins detachably extending through the through holes in the wrench and the hole and the pivot hole in the chain, so as to secure the chain to the wrench.

2. The detachable freewheel turner for a bicycle as claimed in claim 1, wherein the wrench has a box end and a open end.

3. The detachable freewheel turner for a bicycle as claimed in claim 1, wherein the wrench has two open ends.

4. The detachable freewheel turner for a bicycle as claimed in claim 1, wherein the wrench has two box ends.

5. The detachable freewheel turner for a bicycle as claimed in claim 1, wherein the pin has a head portion connected to a body portion and a diameter of the head portion is bigger than that of the body portion, a recess is defined at the abutting end of the pin, a spring and a steel ball are put into the recess in turn.

6. The detachable freewheel turner for a bicycle as claimed in claim 1, wherein the pin has a head portion and two rod-like portions, a size of the head portion is bigger than that of the rod-like portions, a protrusion is formed in one of the rod-like portion.

7. The detachable freewheel turner for a bicycle as claimed in claim 1, wherein the pin has a head portion connected to a body portion and a diameter of the head portion is bigger than that of the body portion, the body portion has a threaded section which is engaged with a nut.

8. The detachable freewheel turner for a bicycle as claimed in claim 1, wherein a through hole is defined adjacent to the hole in the wrench and located in correspondence with the pivot holes of the chain, whereby to adjust the connecting position of the wrench and the chain.
